(19) United States
(12) Patent Application Publication
(10) Pub. No.: US 2005/0142966 A1
(43) Pub. Date: Jun. 30, 2005

(54) Odor control materials and face masks including odor control materials

(75) Inventors: Roger Bradshaw Quincy III, Cumming, GA (US); Ronald Lee Edens, Cumming, GA (US); Francis Joseph Kronzer, Woodstock, GA (US); Eric Steindorf, Roswell, GA (US); Bruce Stokes, Woodstock, GA (US); Leonard E. Zelazoski, Kennesaw, GA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/749,689

(22) Filed: Dec. 31, 2003

(51) Int. Cl. B32B 27/14; B32B 5/16; B32B 27/20

(52) U.S. Cl. 442/72; 427/180; 427/288; 442/73; 442/121; 442/417

(57) ABSTRACT

A nonwoven fabric suitable for odor removal uses is provided. A method of treating fabrics and a face mask that removes odors are also provided.

### BACKGROUND OF THE INVENTION

The present invention relates to materials and products that can be used to alleviate or otherwise reduce odors.

Activated carbon has long been used for the removal of odors and other objectionable compounds. Odor removal by activated carbon and other porous high surface area substances is usually thought to occur by an adsorption mechanism. The term “adsorption” generally refers to the preferential partitioning of substances from a gaseous or liquid phase onto the surface of a solid substrate. Adsorption is not the same as absorption, where a liquid being absorbed interpenetrates the absorbing phase. Although not wishing to be bound by a theory or mechanism for odor removal, the term “sorption” and “sorbent” will be used to refer to absorption and/or adsorption and absorbent and/or adsorbent, respectively.

Prior art activated carbon containing formulations are difficult and/or expensive to work with and methods of applying the activated carbon to a substrate are cumbersome or have not been very successful. Additionally, the final product that is coated or treated with activated carbon does not typically include enough activated carbon to remove objectionable odors and/or the manner or method of incorporating the activated carbon particles in the final product typically has a negative effect on the particles ability to remove odors.

An attempt to impart odor removing properties to paper products is disclosed in U.S. Pat. No. 5,693,385. U.S. Pat. No. 5,693,385 describes paperboard packaging materials that are coated with a rod on one side using an ink that contains activated carbon particles. The disclosed materials are not air permeable and are not suitable for air filtration applications, particularly respiratory products such as face masks.

Accordingly, it would be desirable to provide a method of treating substrates used for filtration products and to provide breathable materials that have odor removing properties for face masks and other filtration applications. It is desirable that anything added to such substrates to reduce odor does not migrate from the product, as has occurred in prior attempts to address odor control. Specifically, odor sorbent particles should not readily abrade from a product in noticeable quantities. Thus, it is clear that a need exists for a process of making materials that reduce or otherwise control odors.

### SUMMARY OF THE INVENTION

The present invention provides a method of treating a nonwoven fabric that includes saturating a nonwoven fabric having an air permeability greater than about 90 m³/min/m² at a surface pressure differential of 1.27 cm of water as measured by ASTM D 737-96 with an aqueous composition including odor sorbing particles. In some embodiments, the nonwoven fabric has an air permeability greater than about 105 m³/min/m² at a surface pressure differential of 1.27 cm of water as measured by ASTM D 737-96 prior to saturating the nonwoven fabric with an aqueous composition including odor sorbing particles. In certain embodiments, the nonwoven fabric removes less than 70 mg pyridine odor per gram of untreated nonwoven fabric before the fabric is treated with the aqueous composition that includes odor sorbing particles. The odor sorbing particles may be carbon particles, activated carbon particles, treated activated carbon particles, untreated activated carbon particles, zeolite particles, silica particles, alumina particles or mixtures thereof. Desirably, the aqueous composition includes a polymeric binder. The polymeric binder may be a latex, a polyacrylate, a polymethacrylate, a copolymer of an acrylate, a copolymer of a methacrylate, a styrene-butadiene copolymer, a styrene-acrylic copolymer, an ethylene-vinyl acetate copolymer, a nitrile rubber, an acrylonitrile-butadiene copolymer or a polyvinyl alcohol binder. In certain embodiments, the aqueous composition includes at least about 10 weight percent of a styrene-acrylic copolymer binder and at least about 10 weight percent of activated carbon particles.

The present invention also provides a nonwoven fabric suitable for filtration purposes, the nonwoven fabric that includes at least 10 weight percent of sorbent particles relative to the weight of the nonwoven fabric, that has an air permeability of at least 40 m³/min/m² at a surface pressure differential of 1.27 cm of water as measured by ASTM D 737-96 and that is capable of removing at least 70 mg of pyridine odor per gram of nonwoven fabric as measured by the Odor Removal Test. Desirably, the sorbent particles do not rub off during normal use. In certain embodiments, the nonwoven fabric has an air permeability of at least 60 m³/min/m² at a surface pressure differential of 1.27 cm of water as measured by ASTM D-737-96 and is capable of removing at least 75 mg of pyridine odor per gram of nonwoven fabric as measured by the Odor Removal Test. In certain embodiments, the nonwoven fabric is a bonded carded web of nonwoven fiber. In certain embodiments, the nonwoven fabric is a bonded carded web of polyester fibers and bicomponent polyethylene sheath/polypropylene core fibers. In certain desirable embodiments, the sorbent particles are or include activated carbon particles.

The present invention also provides a face mask that includes an inner facing layer, a filtration layer and a nonwoven fabric layer treated by saturating the nonwoven fabric layer with an aqueous composition that includes odor sorbing particles. In certain embodiments, the nonwoven fabric layer treated by saturating the nonwoven fabric layer with an aqueous composition that includes odor sorbing particles is the outer facing layer of the face mask and the filtration layer is disposed between the inner facing layer and the nonwoven fabric layer treated with odor sorbing particles. In other embodiments, the face mask includes an outer facing layer and the nonwoven fabric layer treated with an odor sorbing particles is disposed between the filtration layer and the outer facing layer of the face mask. The face mask may further include a fluid resistant layer. And in certain embodiments, the fluid resistant layer is disposed between the nonwoven fabric layer treated with odor sorbing particles and the inner facing layer of the face mask. The fluid resistant layer may be an apertured film.

In yet another desirable embodiment, the present invention includes a face mask that includes: an inner facing layer, a filtration layer comprising a meltblown nonwoven structure, an odor sorbing layer that comprises a bonded carded web treated with an aqueous suspension comprising at least 10 weight percent of a styrene-acrylic copolymer binder and at least about 10 weight percent of activated carbon particles wherein the treated bonded carded web has an air permeability of at least 120 m³/min/m² at a surface pressure differential of 1.27 cm of water as measured by ASTM D 737-96, and an outer facing layer.

### BRIEF DESCRIPTION OF THE DRAWINGS

FIG. 1 is a perspective view of an exemplary embodiment of a face mask being worn by a user.

FIG. 2 is a schematic diagram of a method of treating a substrate in accordance with the present invention.

### TEST METHODS

Air Permeability Test Procedure

In order to test the air permeability or “breathability” of the materials of the present invention as well as comparative materials, air permeability testing was done in accordance with ASTM D-737-96. The equipment used for this test was a TEXTEST FX 3300 with a 38 cm² test head. The test measures the rate and volume of air flow through a fabric under a prescribed surface pressure differential of 0.5 inches (about 1.27 cm) of water gauge pressure. The data were expressed as the rate of air flow in cubic feet per minute per square foot (CFM/ft²) for the 38 cm² test head of fabric, which were converted to m³/min/m² (divide the CFM/ft² reading by 3.28).

Odor Removal Test Procedure

In order to test the effectiveness of applying the sorbent by coating versus saturation, both methods were performed and the resulting material tested. In this test, Nuchar PMA Ink from MeadWestvaco was applied to a wetlaid fabric (from Ahlstrom) that contained cellulose fibers using different surface coating methods including using a blade and a Meyer rod (No. 10 double wound). Other samples of wetlaid fabrics were saturated as described above and dried with steam cans. The odor removing efficiency was measured using a headspace gas chromatography (GC) method with pyridine (amine) as the model odor, which was conducted on an Agilent 5890, Series II gas chromatograph with an Agilent 7694 headspace sampler, both available from Agilent Technologies, Waldbronn, Germany. Helium was used as the carrier gas (injection port pressure: 12.7 psig (188.9 kPa); headspace vial pressure: 15.8 psig (210.3 kPa); supply line pressure: 60 psig (515.1 kPa)). A DB-624 column (available from J&W Scientific, Inc. of Folsom, Calif.) that had a length of 30 m and an internal diameter of 0.25 mm was used for chromatography of the odorous compound.

The operating parameters used for the headspace GC method are shown in the table below.

Operating Parameters for the Headspace Gas Chromatography Device

Headspace Parameters

| | | |
|---|---|---|
| Zone Temps, ° C. | Oven | 37 |
| | Loop | 85 |
| | TR Line | 90 |
| Event Time, minutes | GC Cycle time | 10.0 |
| | Vial eq. Time | 10.0 |
| | Pressuriz. Time | 0.20 |
| | Loop fill time | 0.20 |
| | Loop eq. Time | 0.15 |
| | Inject time | 0.30 |
| Vial Parameters | First vial | 1 |
| | Last vial | 1 |
| | Shake | [off] |

The test procedure involved placing about 0.008 g of a sample containing the odor sorbent in a 20 cubic centimeter (cc) headspace vial. Using a syringe, an aliquot of the odorous compound was also placed in the vial. The vial was then sealed with a cap and a septum and placed in a headspace gas chromatography oven at 37° C. After ten minutes, a hollow needle was inserted through the septum and into the vial. A 1 cc sample of the headspace (air inside the vial) was then injected into the gas chromatograph.

The results of the testing are shown below and it should be noted that due to the mildly acidic nature of the cellulose in the wetlaid fabric, the control does remove some of the pyridine.

### DETAILED DESCRIPTION OF THE PRESENTLY PREFERRED EMBODIMENTS

The present invention describes breathable materials that control odor. The breathable materials can be used for respiratory filtration products such as surgical face masks. The control of odors in face masks is of particular interest to persons using face masks in odorous environments, for example those exposed to laser or cautery surgical procedures. The odorous “surgical smoke” produced by these procedures has been described in many publications, including an AANA Journal article (April 2001, vol. 69, no. 2, p. 125-132) which shows a table of toxic chemical byproducts that includes pyridine. The inventors have found a way to produce a durable treatment of an odor sorbent onto a breathable fabric substrate. The odor sorbent is deposited onto the substrate and dried from a formulation that includes the odor sorbent, binder and water. This odor sorbing formulation may be deposited using a saturation method and remains substantially in place despite the rigors of product use. As used herein, “saturation” includes such processes as dipping and squeezing and generally includes soaking or otherwise immersing a substrate in a solution or emulsion that includes an odor sorbing formulation and does not require that the substrate is loaded to capacity with the solution or emulsion containing the odor sorbing formulation.

The odor sorbent may be, or include, zeolites, silicas, aluminas, titanias, sodium carbonates, sodium bicarbonates, sodium phosphates, zinc and copper sulfates and activated carbon in particle or fiber form, or other chemicals known to control odors, and mixtures thereof. The amount of odor sorbent will vary depending on the effectiveness of the sorbent chosen but should generally be in the range of about 2 to about 80 weight percent, desirably between about 5 and 75 weight percent and more desirably between about 10 and 30 weight percent. A particularly suggested odor sorbent includes, but is not limited to, activated carbon particles. Activated carbon particles are desirable for odor control uses because activated carbon particles can sorb, that is absorb and/or adsorb, odors.

Suggested compositions for treating filtration substrates in accordance with the present invention include compositions that include odor sorbing particles including, but not limited to, carbon particles, activated carbon particles, treated activated carbon particles, untreated activated carbon particles, zeolite particles, silica particles, alumina particles and the like. Desirably, the odor sorbing particles have high surface areas and are porous. One suggested class of odor sorbing particles that are porous and that have high surface area includes, but is not limited to, activated carbon particles. Compositions that include such activated carbon particles and that are suggested for producing materials in accordance with the present invention include Nuchar PMA Ink, obtained from MeadWestvaco Corporation of Covington, Va., and other ink formulations that were also obtained from MeadWestvaco under the designations DPX-8433-68A, DPX-8433-68B and DPX-7861-49A. Generally, these compositions are aqueous emulsions of water, a polymer binder and activated carbon particles. More specifically, these compositions are aqueous emulsions of water, at least 10 weight percent of a polymer binder and at least 10 weight percent of activated carbon particles. Desirably, the polymer binder is a styrene-acrylic copolymer. For example, Nuchar PMA Ink is an aqueous emulsion that includes from 11 to 14 weight percent of a proprietary styrene-acrylic copolymer, from 14 to 16 weight percent activated carbon and from 70 to 85 weight percent water. DPX-8433-68A and DPX-8433-68B inks are aqueous emulsions that include from 20 to 24 weight percent of a proprietary styrene-acrylic copolymer, from 12 to 16 weight percent activated carbon and from 62 to 66 weight percent water. And, DPX-7861-49A ink is an aqueous emulsion of from 9 to 13 weight percent of a proprietary styrene-acrylic copolymer, from 14 to 16 weight percent activated carbon and from 70 to 75 weight percent water. Other sorbent products are available from the Calgon Carbon Corporation of Pittsburgh, Pa., USA, under the trade name CARBABSORB®, from Sigma-Aldrich Chemical Company of Milwaukee, Wis. and from Cabot Corporation of Boston, Mass.

Other water-based binders that are suggested include, but are not limited to, latex binders; polyacrylates, including polymethacrylates, poly(acrylic acid), poly(methacrylic acid), and copolymers of the various acrylate and methacrylate esters and free acids of these esters; styrene-butadiene copolymers; ethylene-vinyl acetate copolymers; nitrile rubbers or acrylonitrile-butadiene copolymers and so forth. Water-soluble binders such as polyvinyl alcohol are also suggested and may be suitable as a binder for the sorbent particles. Suggested latex binders include latex binders that are commonly used for saturation of cellulose substrates, for example the latex binders disclosed in U.S. Pat. No. 5,595,828 to Weber et al.

The odor sorbent of the invention may be applied onto a substrate, for example a nonwoven fabric, from an aqueous based formulation, dried, and the dried substrate placed in the product. Alternatively, the formulation containing the sorbent may be applied onto an existing layer within the product, such as the filtration layer in a face mask, and allowed to dry. Substrates suitable for treatment with the sorbents of the invention include films, tissues, paper towels, woven and nonwoven fabrics, such as coform materials, airlaid materials, wet-laid materials, bonded-carded webs, spunbonded materials, meltblown materials and so forth. Nonexclusive examples of substrates may be found in U.S. Pat. Nos. 4,775,582, 4,853,281, 4,833,003, and 4,511,488, all assigned to the Kimberly-Clark Corporation.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting surface.

A nonwoven fabric may be made according to processes like spunbonding, meltblowing, airlaying, bonding and carding, and so forth. Nonwoven fabrics may be made from thermoplastic resins including, but not limited to polyesters, nylons, and polyolefins. Olefins include ethylene, propylene, butylenes, isoprene and so forth, as well as combinations thereof. Desirably, the substrate that is treated in accordance with the present invention includes a component that is hydrophilic, for example pulp fibers, or fibers that are treated to be more hydrophilic so that the composition containing odor sorbing particles will wet the substrate. Suggested substrates include, but are not limited to: bonded carded webs, particularly bonded carded webs that contain some hydrophilic fibers such as rayon fibers or are treated with a composition to increase the hydrophilicity of the fibers that make up the bonded carded web, spunbonded webs, particularly polyolefin spunbonded webs; meltblown webs, particularly polyolefin meltblown webs; and wetlaid composite webs of pulp and polyester fibers. Other suggested substrates include, but are not limited to, wetlaid webs, melt spun webs such as spunbond and meltblown webs, airlaid webs, solvent spun webs, coform webs, hydroentangled webs, and other types of webs, desirably webs that contain some hydrophilic fibers or contain some fibers that have or can be treated to be more hydrophilic so that the composition containing odor sorbing particles will wet the substrate.

The term “coform” means a process in which at least one meltblown diehead is arranged near a chute through which other materials are added to the web while it is forming. Such other materials may be pulp, superabsorbent particles, natural polymers (for example, rayon or cotton fibers) and/or synthetic polymers (for example, polypropylene or polyester) fibers, for example, where the fibers may be of staple length. Coform processes are shown in commonly assigned U.S. Pat. No. 4,818,464 to Lau and U.S. Pat. No. 4,100,324 to Anderson et al. Webs produced by the coform process are generally referred to as coform materials.

A bonded carded web is made from staple fibers which are sent through a combing or carding unit, which breaks apart and aligns the staple fibers in the machine direction to form a generally machine direction-oriented fibrous nonwoven web. Once the web is formed, it then is bonded by one or more of several methods such as powder bonding, pattern bonding, through air bonding and ultrasonic bonding. Meltable fibers, called binder fibers, are included in carded webs to enable through air bonding. The amount of binder fibers included depends on the degree of bonding needed, the basis weight of the web and the fiber lengths and deniers. Generally, more binder fibers will give a stronger, denser and less porous structure. Through air bonded carded webs having as little as 5 percent binder fibers and as much as 100 percent binder fibers are possible.

In the airlaying process, bundles of small fibers having typical lengths ranging from about 3 to about 52 millimeters (mm) are separated and entrained in an air supply and then deposited onto a forming screen, usually with the assistance of a vacuum supply. The randomly deposited fibers then are bonded to one another. Examples of airlaid teachings include the DanWeb process as described in U.S. Pat. No. 4,640,810 to Laursen et al. and assigned to Scan Web of North America Inc, the Kroyer process as described in U.S. Pat. No. 4,494,278 to Kroyer et al. and U.S. Pat. No. 5,527,171 to Soerensen assigned to Niro Separation and the method described U.S. Pat. No. 4,375,448 to Appel et al assigned to Kimberly-Clark Corporation, or other similar methods.

The basis weight of the nonwoven substrate can vary from about 7 gsm (about 0.2 osy) to about 100 gsm (about 3 osy). For applications in which high breathability of the fabric are desired, the basis weight is desirably less than about 34 gsm (about 1.0 osy and more desirably less than about 24 gsm (about 0.7 osy). For bonded carded webs at lower basis weight, the proportion of bicomponent fibers should be increased to increase the amount of bondable fibers to improve the bonding of the fibers to each other and to other optional layers during manufacture.

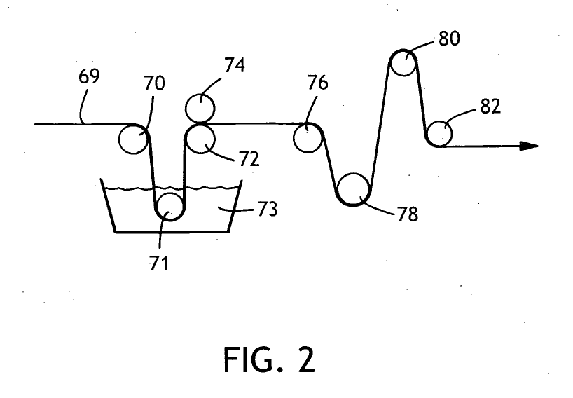

The sorbent may be applied to the substrate layer by a fluid saturation method such as the dip and squeeze method, which entails dipping the layer into a liquid that may be a solution or emulsion of the sorbent and a binder, squeezing out the excess, and drying. The sorbent may be applied to the layer with a saturation treater and then dried with, for example, steam cans. This method is illustrated in FIG. 2 wherein a wetlaid fabric 69 travels around rollers 70, 71 through a reservoir 73 and then between a rubber roll 74 and a stainless steel roll 72 where it is “nipped” or squeezed to remove excess liquid. The wet wetlaid fabric 69 is then dried over four steam cans 76, 78, 80, and 82, and then wound into a roll. In one example, the nip pressure between the rubber and stainless steel rolls was 92 psi (about 634 Kilopascals, KPa), the amount of odor sorbent and binder applied was in the range of 100 to 127 weight percent, the feed rate was 28 ft/min (8.53 m/min) and the steam can temperatures were, respectively, 176° F., 170° F., 185° F. and 191° F. (80.0, 76.7, 85.0, and 88.3° C.). Alternatively the wetted fabric may be dried by other means such as through the use of through-air drying. It is believed that a saturation process allows particles of the odor sorbent to be adhered, coated or otherwise bound to fibers not only on the surfaces of the outer nonwoven substrate but also to fibers within the nonwoven material structure.

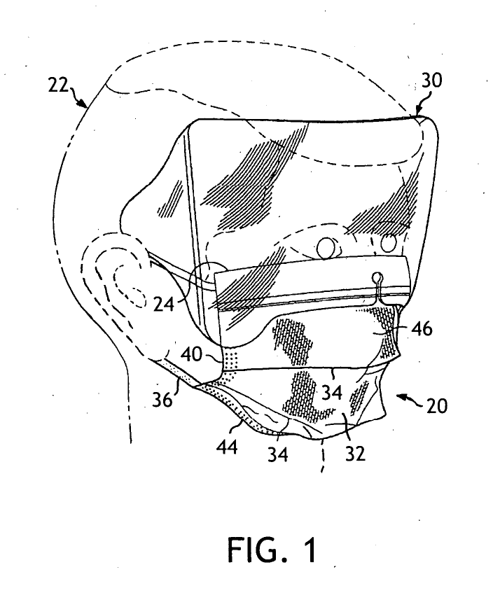

In one desirable embodiment, the present invention provides an air pervious substrate that includes at least 10 weight percent of sorbent particles relative to the weight of the substrate and that has an air permeability of at least 40 m³/min/m² at a differential water gauge pressure of 0.5 inches (about 1.27 cm) as measured by ASTM D 737-96 and is capable of removing at least 70 mg of pyridine odor per gram of substrate as measured by the Odor Removal Test Procedure described above. Such a substrate is suitable for air filtration uses, for example a face mask. Thus, the present invention also provides a face mask that includes at least 10 weight percent of sorbent particles relative to the weight of a substrate that is a component of the face mask which has an air permeability of at least 40 m³/min/m² at a differential water gauge pressure of 125 Pa (0.5 inches [about 1.27 cm] of water) as measured by ASTM D-737-96 and is capable of removing at least 70 mg of pyridine odor per gram of substrate as measured by the Odor Removal Test Procedure. An exemplary face mask, specifically a surgical face mask, is illustrated in FIG. 1.

The following detailed description will be made in the context of a surgical face mask. It is readily apparent, however, that other articles that would benefit by providing odor removal should also be considered within the present invention and may benefit from substrates and/or methods of the present invention. Suggested articles that could benefit by including substrates and/or methods in accordance to the present invention include, but are not limited to, medical face masks such as surgical face masks which use ties to attach to the head, industrial respirators, and face masks, HVAC filtration products and the like. In addition, the invention will be described in the context of its various configurations. It should be appreciated that alternative arrangements of the invention can comprise any combination of such configurations.

FIG. 1 illustrates an exemplary face mask. The illustrated, exemplary face mask 20 includes a filter body 32 attached to an optional visor 30. The filter body 32 is designed to filter air breathed through the nose and/or mouth of a wearer 22 of the mask 20. The filter body 32 may be formed in any manner known to those skilled in the art. In the embodiment depicted in FIG. 1, for instance, the filter body 32 has a generally rectangular configuration defined in part by a top edge 24, opposite side edges 40 (only one of which is shown in FIG. 1), and a bottom edge 44. The illustrated and exemplary filter body 32 also includes optional but suggested multiple pleats 34 to effectively cover the nose and mouth of the wearer 22. The filter body 32 includes an exterior surface 46 and an interior surface (not shown). The pleats 34 allow the filter body 32 to bellow outwardly and easily conform to the general contours of the face of wearer 22. The pleats 34 cooperate with each other to allow the filter body 32 to expand and contract during breathing of the wearer 22, without compromising a fluid seal formed between the perimeter of the filter body 32 and adjacent portions of the face of wearer 22. With increased concern for highly toxic bacteria and chemicals, wearers of face masks are particularly interested in preventing any fluid communication between the periphery of the face mask and adjacent portions of the wearer's face.

As will be appreciated by those skilled in the art, the filter body 32 may be constructed from any of a variety of different materials and contain any number of desired layers. In one embodiment, for instance, the filter body 32 includes four (4) distinct layers. For example, the outermost layer that defines the exterior surface 46 of the filter body 32 may be a cover stock layer that includes cellulosic fibers. The cover stock layer may be chemically coated or treated, such as with a liquid repellant, to render the cover stock resistant to liquids. In one embodiment, the cover stock layer includes sorbent particles. A filtration layer may be positioned adjacent to the cover stock layer. The filtration layer may contain, for instance, a nonwoven web or laminate. The filtration layer inhibits the passage of microscopic airborne contaminants and microbes in either direction. In another embodiment, an additional layer that includes sorbent particles is included in the face mask. The odor sorbing layer may be a bonded carded web treated with a composition that includes odor sorbing activated carbon particles as described herein. The odor sorbent containing layer is desirably located between the outer cover stock layer and the filtration layer but may be located anywhere between the two outer layers. Alternatively, one or both of the outer layers or any of the other layers may include odor sorbing particles.

A barrier layer may be positioned adjacent to the filtration layer. One example of such a barrier material is a low density polyethylene film as described in U.S. Pat. No. 4,920,960 and is hereby incorporated by reference herein. The barrier layer may possess small apertures that prevent liquids with a relatively high surface tension from passing therethrough, yet allow gases with a low surface tension to pass. The barrier layer is designed to freely pass gases in either direction, while restricting the passage of liquids in at least one direction. The cover stock and filtration layers aid the barrier layer by slowing down any liquid that may be splashed, sprayed or thrown at the filter body 32. By requiring the liquid to pass through these two outer layers prior to reaching the barrier material 34, the liquid will have less pressure and the barrier material 34 will be better able to prevent passage of the liquid. The innermost layer adjacent to the face of the wearer 22 may be constructed of a lightweight and highly porous non-woven fabric. The innermost layer is designed to prevent unwanted materials, such as facial hair, loose fibers, or beads of perspiration, from contacting the other layers, which could wick liquids through the filter body 32. The innermost layer also provides a comfortable surface for contact with the face of the wearer.

Although various configurations have been described above, it should be understood that the present invention is not limited to any particular face mask or visor configuration. For example, the face mask may be of a variety of styles and geometries, such as, but not limited to, flat half masks, pleated masks, cone masks, flat-folded personal respiratory devices, duckbill style masks, trapezoidally shaped masks and so forth. Exemplary face masks, face mask designs and face mask components are described and illustrated in U.S. Pat. No. 5,724,964, U.S. Pat. No. 5,322,061 and U.S. Pat. No. 4,920,960 which are all hereby incorporated by reference herein.

Although the face masks described above have a substantially square or rectangular body portion and are attached to a wearer by as many as four tie strips, other face mask designs are within the scope of the present invention. Another exemplary suitable face mask design is illustrated and described in U.S. Pat. No. 4,662,005, assigned to Kimberly-Clark Corporation, wherein the face mask has a cup or pouch-like configuration, which engages with a wearer's chin and also has two tie strings on opposite sides of an upper edge for tying around a wearer's head. Other designs are also within the scope of the present invention. Alternate face masks designs that can be used for the present invention, include, but are not limited to, the designs illustrated in U.S. Design Pat. Nos. 347,090 and 347, 713 and/or described in U.S. Pat. Nos. 5,322,061 and 6,173,712, which are issued to Brunson et al. and are hereby incorporated herein by reference in their entireties.

In order to test the effectiveness of applying the sorbent by coating versus saturation, both methods were performed and the resulting materials were tested as well as other materials for comparative purposes.

### EXAMPLE 1

Example 1 is an example of a substrate suitable for filtration uses that was made in accordance with the present invention. The substrate of Example 1 consisted of a 18.6 gram per square meter (gsm) wetlaid fabric obtained from Ahlstrom under the trade name Dexter® 11399 outer face mask coverstock. According to the data sheet for the Dexter® 11399 outer face mask coverstock, the coverstock is a wet formed, lightweight and highly breathable nonwoven fabric having an air permeability of 1,300 L/min/100 cm². The coverstock fabric contains a proportion of thermoplastic fibers that makes the fabric suitable for thermobonding and/or ultrasonic assembly techniques that can be used during manufacturing processes.

The coverstock fabric was treated on a pilot line with Nuchar PMA Ink obtained from MeadWestvaco by dipping and squeezing the wetlaid fabric in the Nuchar PMA Ink at a rate of about 15 feet per minute. Nuchar PMA Ink is an aqueous emulsion that includes about 14-16 weight percent activated carbon and about 11-14 weight percent of a styrene-acrylic copolymer binder. The saturated wetlaid fabric was run through a nip and then dried using two steam cans to produce a treated wetlaid fabric with a 20 weight percent add-on level of activated carbon particles. The treated wetlaid material was tested for air permeability and odor removal properties. The results of the tests as well as the results of the same test on other materials are present in Table 1 below.

### EXAMPLE 2

Example 2 is another example of a substrate suitable for filtration uses that was made in accordance with the present invention. The substrate of Example 2 was also Dexter® 11399 outer face mask coverstock obtained from Ahlstrom. The coverstock fabric of Example 2 was treated off line with DPX-8433-68A ink obtained from Mead Westvaco by dipping and saturating the wetlaid fabric in a solution made with 213 grams of the DPX-8433-68A ink and 94 grams of distilled water. The saturated wetlaid fabric was run through a nip and then dried using one stationary steam can to produce a treated wetlaid fabric with a 14 weight percent add-on of activated carbon particles. The treated wetlaid material of Example 2 was tested for air permeability and odor removal properties. The results of the tests on the filtration material of Example 2 are presented in Table 1 below.

### EXAMPLE 3

Example 3 is yet another example of a porous, 3-dimensional substrate in accordance with the invention. The porous, 3-dimensional substrate of Example 3 consisted of a 0.9 ounce per square yard (osy) bonded carded web (BCW) made from two types of fibers. The first type of fiber was 3 denier bicomponent fibers that consisted of a polypropylene core component and a polyethylene sheath component. The bicomponent fibers were obtained from E.S. Fibervisions of Athens, Ga. that had been pretreated with HR6 proprietary finish by E.S. Fibervisions at an add-on level of 0.5 weight percent. The second type of fiber used to make the BCW was 6 denier polyester staple fibers, specifically poly(ethylene terephthalate) fibers, obtained from KoSa of Houston, Tex. The PET fibers had been pretreated by the supplier with a L-1 finish applied at 0.55 weight percent. L-1 finish is a blend of ethoxylated hydrogenated castor oil and sorbitan monooleate. The fibers may further include lubricant and anti-static agents to ease the carding process. The 0.9 osy BCW consisted of about 75 weight percent of the PE sheath/PP core fibers and about 25 weight percent of the PET fibers. Bonding of the web was done by hot air impingement, a process which provides a bulky structure since the web is not compressed by hot rollers or the like when it is heated. Specifically, bonding was accomplished via a through air bonder (TAB) at about 263+/−3° F. temperature and about 2 inches water of hood pressure.

The BCW fabric of Example 3 was treated off line with DPX-8433-68A ink obtained from Mead Westvaco by dipping and saturating the BCW fabric in the DPX-8433-68A ink and distilled water solution described in Example 2. The saturated BCW fabric was run through a nip and then dried using one stationary steam can to produce a treated BCW fabric with a 30 weight percent add-on of activated carbon particles. The treated BCW material was tested for air permeability and odor removal properties. The results of the tests on the BCW filtration material of Example 3 are presented in Table 1 below.

### EXAMPLE 4

Example 4 was made using the same materials and process as in Example 3 above except that Example 4 was saturation treated with DPX-8433-68B ink obtained from MeadWestvaco. The process produced a treated BCW fabric with a 56 weight percent add-on of activated carbon particles. The treated BCW material of Example 4 was also tested for air permeability and odor removal properties. The results of the tests on the BCW filtration material of Example 4 are presented in Table 1 below.

### EXAMPLES 5 AND 6

Examples 5 and 6 were made using the process as described for Example 3 above except that Examples 5 and 6 were made starting with a 0.55 osy polypropylene spunbonded (SB) material. The spunbonded material was produced by Kimberly-Clark. The SB material of Example 5 was treated off line with the DPX-8433-68A ink and distilled water solution described in Example 2 and Example 6 was treated off line with the DPX-8433-68B ink. The processes produced treated SB fabrics with a 31 and 47 weight percent add-on of activated carbon particles, respectively. The treated SB material of Example 5 was tested for odor removal properties, and the treated SB material of Example 6 was tested for air permeability. The results of the tests on the SB filtration material of Examples 5 and 6 are presented in Table 1 below.

### EXAMPLE 7

Example 7 was made using the process as described for Example 3 above except that Example 7 was made using a 10 gsm polypropylene spunbonded/meltblown/spunbonded (SMS) laminate material. The SMS material was produced by Kimberly-Clark. Example 7 was treated off line with the DPX-8433-68A ink and distilled water solution described in Example 2. The process produced a treated SMS fabric with a 39 weight percent add-on of activated carbon particles. The treated SMS material of Example 7 was tested for air permeability. The results of the test on the SMS filtration material of Example 7 are presented in Table 1 below.

### EXAMPLE 8

Example 8 was made using the process as described for Example 3 above except that Example 8 was made using a 10 gsm SMS laminate material of Example 7. Example 8 was treated off line with DPX-8433-68A ink. The processes produced a treated SMS fabric with a 70 weight percent add-on of activated carbon particles. The treated SMS material of Example 8 was tested for air permeability and odor control properties. The results of the test on the SMS filtration material of Example 8 are presented in Table 1 below.

TABLE 1

| | | Air | |
|---|---|---|---|
| | | Permeability, | |
| | | cfm/ft² | |
| | | at 125 Pa | mg PYR odor |
| | Carbon | (m³/min/m² at | removed per |
| Example no./Description | in percent | 1.27 cm water) | gram of sample |
| Comparative Example A - Dexter ® white | 0 | 380 (116) | 53 |
| wetlaid fabric without activated carbon | | | |
| Comparative Example B - Dexter ® white | 3.3 | 208 (63.4) | 54 |
| wetlaid fabric w/Nuchar PMA Ink coated | | | |
| on one side by blade | | | |
| Comparative Example C - Dexter ® white | 6.3 | 124 (37.8) | 60 |
| wetlaid fabric w/Nuchar PMA Ink coated | | | |
| on one side by rod | | | |
| Comparative Example D - Dexter ® white | 10.9 | 37 (11.3) | 75 |
| wetlaid fabric w/Nuchar PMA Ink coated | | | |
| on one side by blade | | | |
| Comparative Example E - Dexter ® | 0 | 341 (104) | 64 |
| 11399 wetlaid fabric without activated | | | |
| carbon | | | |
| Example 1 - wetlaid fabric saturation | 20 | 137 (41.8) | 90 |
| treated on-line with Nuchar PMA Ink | | | |
| Example 2 - wetlaid fabric saturation | 14 | 204 (62.2) | 78 |
| treated off-line with DPX-8433-68A ink | | | |
| Comparative Example F - 0.9 osy BCW | 0 | 1070 (326) | 9 |
| fabric without activated carbon | | | |
| Example 3 - 0.9 osy BCW saturation | 30 | 652 (199) | 79 |
| treated off-line with DPX-8433-68A ink | | | |
| Example 4 - 0.9 osy BCW saturation | 56 | 423 (129) | 90 |
| treated off-line with DPX-8433-68B ink | | | |
| Comparative Example G - 0.55 osy SB | 0 | 623 (190) | 14 |
| fabric without activated carbon | | | |
| Example 5 - 0.55 osy SB fabric | 31 | — | 93 |
| saturation treated off-line with DPX-8433- | | | |
| 68A ink | | | |
| Example 6 - 0.55 osy SB fabric | 47 | 153 (46.6) | — |
| saturation treated off-line with DPX-8433- | | | |
| 68B ink | | | |
| Comparative Example H - 10 gsm SMS | 0 | 571 (174) | 14 |
| fabric without activated carbon | | | |
| Example 7 - 10 gsm SMS fabric treated | 39 | 54 (16.5) | — |
| off-line with DPX-8433-68A ink | | | |
| Example 8 - 10 gsm SMS fabric treated | 70 | 10 (3.0) | 105 |
| off-line with DPX-8433-68A ink | | | |

The test data show that materials treated by a saturation process such as a dip-and-squeeze process were able to be loaded with a greater relative amount of activated carbon particles while retaining acceptable air permeability, for example greater than 100 CFM/ft² (30 m³/min/m²) and desirably greater than 200 CFM/ft² (60 m³/min/m²), unexpectedly higher than the permeability of materials coated by rod or blade with the same ink formulation. In addition, the saturation treated materials had better odor removing properties as measured by the Odor Removal Test with pyridine.

Additionally, the examples in accordance with the present invention were tested qualitatively for rub-off by a test subject rubbing samples of the fabrics between the thumb and fingers. The examples in accordance with the invention exhibited little or no rub-off and were superior in rub-off performance compared to the samples produced by the blade or rod coating technique even though the blade and rod coated examples included much lower levels of activated carbon.

Generally, the formulation of the Examples containing sorbent particles and binder dries to produce a durable treatment that will resist tendencies to migrate or fall off when in use or transport. Durability may be measured by placing the substrate between the thumb and forefinger and rubbing the two together. Little or no sorbent should be left on the fingers. Another test, widely used in the flexographic printing industry, is to place the treated substrate on a hard surface, place one's thumb on the substrate, and rotate the thumb about 90 degrees. Again, little or no sorbent should be left on the thumb. This “thumb twist” test is further described in C Lowi, G. Webster, S. Kellse and I. McDonald's “Chemistry & Technology for UV & EB Formulation for Coatings, Inks & Paints” volume 4, p. 54, published in 1997 by John Wiley & Sons Ltd. in association with SITA Technology, Ltd., ISBN 0 947798 54 4, and in C. Lowe and R. K. T. Oldring's “Test Methods for UV and EB Curing Systems”, volume 6, published in 1998 by John Wiley and Sons Ltd in association with SITA Technology Ltd., ISBN 0471 978906. This test is subject to some variability as the pressure applied by a particular tester may vary, but is surprisingly accurate under most conditions. This test may be correlated generally with the Taber Abrasion test which measures the number of cycles required for an abrasion wheel to wear completely through a fabric.

In the Taber Abrasion test a sample of fabric is placed on a turntable that rotates in the horizontal plane while an abrasive wheel rests on the sample as it turns. The wheel turns at the same rate as the turntable which turns at a rate of about 30 to 45 revolutions per minute. Wheels of varying degrees of abrasiveness are available. The Taber Abrasion testing device is available from Teledyne Taber, North Tonawanda, N.Y., USA as model number 5130, with an H-38 wheel and 125 gram counterweight. In this configuration the samples according to the invention should endure at least 10 cycles without a visible amount of sorbent being transferred to the wheel.

While the present invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A method of treating a nonwoven fabric comprising:
a. providing a nonwoven fabric having an air permeability greater than about 90 m³/min/m² at a surface pressure differential of 1.27 cm of water as measured by ASTM D 737-96; and
b. saturating the nonwoven fabric with an aqueous composition comprising odor sorbing particles.

2. The method of claim 1, wherein the nonwoven fabric has an air permeability greater than about 100 m³/min/m² at a surface pressure differential of 1.27 cm of water as measured by ASTM D 737-96 prior to saturating the nonwoven fabric with an aqueous composition comprising odor sorbing particles.

3. The method of claim 1, wherein the nonwoven fabric that is provided can remove less than 70 mg pyridine odor per gram of untreated nonwoven fabric before saturating the nonwoven fabric with an aqueous composition comprising odor sorbing particles.

4. The method of claim 1, wherein the odor sorbing particles are selected from the group consisting of carbon particles, activated carbon particles, treated activated carbon particles, untreated activated carbon particles, zeolite particles, silica particles, alumina particles and mixtures thereof.

5. The method of claim 1, wherein aqueous composition further comprises a polymeric binder.

6. The method of claim 5, wherein the polymeric binder is selected from the group consisting of latex binders, polyacrylates, polymethacrylates, copolymers of acrylates, copolymers of methacrylates, styrene-butadiene copolymers, styrene-acrylic copolymers, ethylene-vinyl acetate copolymers, nitrile rubbers, acrylonitrile-butadiene copolymers and polyvinyl alcohol binders.

7. The method of claim 1, wherein aqueous composition comprises at least about 10 weight percent of a styrene-acrylic copolymer binder and at least about 10 weight percent of activated carbon particles.

8. A nonwoven fabric suitable for filtration purposes, the nonwoven fabric comprising at least 10 weight percent of sorbent particles relative to the weight of the nonwoven fabric and having an air permeability of at least 40 m³/min/m² at a surface pressure differential of 1.27 cm of water as measured by ASTM D 737-96 and is capable of removing at least 70 mg of pyridine odor per gram of nonwoven fabric as measured by the Odor Removal Test.

9. The nonwoven fabric of claim 8, wherein the sorbent particles do not rub off during normal use.

10. The nonwoven fabric of claim 8 having an air permeability of at least 60 m³/min/m² at a surface pressure differential of 1.27 cm of water as measured by ASTM D-737-96 and capable of removing at least 75 mg of pyridine odor per gram of nonwoven fabric as measured by the Odor Removal Test.

11. The nonwoven fabric of claim 8, wherein the nonwoven fabric comprises a bonded carded web of fibers.

12. The nonwoven fabric of claim 8, wherein the nonwoven fabric comprises a bonded carded web of bicomponent fibers and cellulosic fibers.

13. The nonwoven fabric of claim 8, wherein the sorbent particles comprise activated carbon particles.

14. A face mask comprising an inner facing layer, a filtration layer and a nonwoven fabric layer treated by saturating the nonwoven fabric layer with an aqueous composition comprising odor sorbing particles.

15. The face mask of claim 14, wherein the nonwoven fabric layer treated by saturating the nonwoven fabric layer with an aqueous composition comprising odor sorbing particles is the outer facing layer of the face mask and the filtration layer is disposed between the inner facing layer and the nonwoven fabric layer treated by saturating the nonwoven fabric layer with an aqueous composition comprising odor sorbing particles.

16. The face mask of claim 14 further comprising an outer facing layer wherein the nonwoven fabric layer treated by saturating the nonwoven fabric layer with an aqueous composition comprising odor sorbing particles is disposed between the filtration layer and the outer facing layer of the face mask.

17. The face mask of claim 16 further comprising a fluid resistant layer.

18. The face mask of claim 17 wherein the fluid resistant layer is disposed between the nonwoven fabric layer treated by saturating the nonwoven fabric layer with an aqueous composition comprising odor sorbing particles and the inner facing layer of the face mask.

19. The face mask of claim 17, wherein the fluid resistant layer is an apertured film.

20. A face mask comprising
an inner facing layer,
a filtration layer comprising a meltblown nonwoven structure,
an odor sorbing layer that comprises a bonded carded web treated with an aqueous composition comprising at least 10 weight percent of a styrene-acrylic copolymer binder and at least about 10 weight percent of activated carbon particles wherein the treated bonded carded web has an air permeability of at least 120 m³/min/m² at a surface pressure differential of 1.27 cm of water as measured by ASTM D 737-96, and
an outer facing layer.
